(19) United States
(12) Patent Application Publication
(10) Pub. No.: US 2015/0064414 A1
(43) Pub. Date: Mar. 5, 2015

(54) Primerless Edge Banding

(71) Applicant: Harry V. Empting, JR., Lake City, TN (US)

(72) Inventor: Harry V. Empting, JR., Lake City, TN (US)

(21) Appl. No.: 14/535,785

(22) Filed: Nov. 7, 2014

Related U.S. Application Data
(63) Continuation-in-part of application No. 12/437,148, filed on May 7, 2009, now abandoned.
(60) Provisional application No. 61/051,449, filed on May 8, 2008.

(51) Int. Cl. B32B 3/08; B32B 7/12; B32B 37/12; B32B 27/30; B32B 27/32; B32B 37/18; B32B 27/08

(52) U.S. Cl. CPC B32B 3/08; B32B 37/182; B32B 7/12; B32B 27/08; B32B 27/306; B32B 27/32; B32B 37/12; B32B 2250/02; B32B 2250/246; B32B 2255/10; B32B 2255/26; B32B 2323/04; B32B 2323/10; B32B 2331/04; B32B 2479/00
USPC 428/192; 156/244.11

(57) ABSTRACT

The present invention pertains to bonding an edge banding to the edge of wood or wood composite furniture by using a co-extruded dual compound polypropylene edge band that contains a main body of polypropylene and a primerless EVA backing layer. The edge of the wood or wood composite material is bonded to a polypropylene edge band by an EVA-based glue applied by an edge banding machine at the point of furniture manufacture. Bonding between the edge band and composite wood material is achieved without the use of a primer.

### CROSS-REFERENCE TO RELATED APPLICATIONS

This Application is a continuation-in-part of U.S. patent application Ser. No. 12/437,148, filed May 7, 2009, which in turn claims the benefit under 35 U.S.C. §119(e) of U.S. Provisional Patent Application Ser. No. 61/051,449, filed May 8, 2008. The entire contents of both applications are incorporated herein by reference.

### STATEMENT REGARDING FEDERALLY SPONSORED RESEARCH OR DEVELOPMENT

Not Applicable

### BACKGROUND OF THE INVENTION

1. Field of Invention

The present invention pertains to flexible or rigid edge banding for wood or wood composite furniture and more particularly to an improved edge banding comprising co-extruded dual compound edge banding that contains a main body of polypropylene edge band and an ethylene-vinyl acetate backing layer that replaces primer.

2. Description of the Related Art

Edge banding is used as a protective and decorative covering for the edge of composite board or plywood, which has a decorative top surface, such as Formica, for example. This type of construction is very often used in the production of office furniture. Both the edge banding and the laminate are generally secured to the board with an adhesive.

In the past, edge banding has commonly been formed from PVC. PVC has good abrasion resistance and trims easily. However, PVC does not adhere well unless the edge banding is coated with a primer. Improper application of primer leads to delamination of the edge banding. Primers also make an edge banding less “green” because they involve the use of various solvents and other chemicals that are not “green.” Further, primers make an edge banding less reliable in the long term due to the simple fact that when using primers to improve bonds, the connection relies upon a very thin surface chemical bond between the primer and the glue, and between the primer and the polypropylene. Additionally, PVC is dangerous to the environment because of migrating plasticizer and because, if burned, PVC decomposes to release chlorine gas, a dangerous chemical. PVC primers also have a limited shelf-life.

Polypropylene is a thermoplastic random copolymer or homopolymer which is generally environmentally “friendly.” However, polypropylene does not adhere well to adhesives, even when a primer is applied to the edge band. In the conventional current state of the art, the need to treat the surface or use a two-part primer is necessary for the primer to stick to the polypropylene main body.

### BRIEF SUMMARY OF THE INVENTION

In some of its embodiments, the present invention comprises an edge banding for a support surface, such as the edge of wood or wood composite furniture, this edge banding using a co-extruded dual compound edge banding that contains a main body of polypropylene edge band and an ethylene-vinyl acetate (EVA) backing layer. The edge banding is applied to at least one edge of a table top or other furniture surface member, the surface member generally being fabricated from particleboard or a wood composite. In an example embodiment, a wood composite layer is covered on one side by a layer of formica and on the opposite side by a layer of paper or similar material. The edge of the wood composite layer is bonded to a polypropylene edge band by a primerless EVA backer. Generally the polypropylene edge band and the primerless EVA backer are coextruded. The primerless EVA backing is bonded onto the polypropylene edge band inside an extrusion die.

At the site of furniture manufacturing, the coextruded edge band and EVA backer are then fed into an edge banding machine; the edge of the wood composite material to which the edge band and EVA backer is to be applied is also fed into the edge banding machine. As the coextruded polypropylene edge band and primerless EVA backer are fed into the machine, heated EVA-based glue is applied to the primerless EVA backer or the composite wood material. The hot EVA-based glue heats and softens primerless EVA backer, so that primerless EVA backer and the EVA-based glue are bonded at a molecular level. The edge band, softened primerless EVA backer, and still-hot EVA-based glue are pressed onto the edge of the wood composite material under pressure. The hot EVA-based glue permeates the wood composite material, forming a mechanical bond between the wood composite material and the primerless EVA backer and EVA-based glue. The heat of the EVA-based glue and the pressure from the edge banding machine further strengthens the primerless polypropylene edge band to the mixed primerless EVA backer and EVA-based glue.

Using the coextruded primerless EVA backer and the EVA-based glue to link the polypropylene edge band with the composite wood material results in a strong, “green” bonding between the polypropylene edge band with the composite wood material. Significantly, this bonding between the edge band and the composite wood material is achieved without the use of a primer. Primers make an edge banding less “green” because they involve the use of various solvents and other chemicals that are not “green.” Furthermore, primers have a shelf-life of a few years at most, and the shelf-life of a primerless edge banding material is considerably longer.

In some example embodiments of the present general inventive concept, a method of applying an edge banding to a support surface without primer includes coextruding an edge band layer and an ethylene-vinyl acetate (EVA) backing layer such that a bond forms between the edge band layer and the EVA backing layer, forming a primerless edge banding, and applying an EVA-based glue to a support surface such that a bond forms between the EVA-based glue layer and the support surface, wherein the bonding between the EVA-based glue layer and the support surface is achieved without the use of a primer

In some embodiments, the edge band layer comprises polypropylene.

In some embodiments, the edge band layer comprises a material selected from the group consisting of polyethylene, polyvinyl chloride, and acrylonitrile butadiene styrene.

In some embodiments, the ethylene-vinyl acetate backing layer comprises ethylene-vinyl acetate with at least 18% vinyl acetate content.

In some embodiments, the ethylene-vinyl acetate backing layer comprises ethylene-vinyl acetate with between 18% and 26% vinyl acetate content.

In some example embodiments of the present general inventive concept, an edge banding for a composite surface includes a polymer edge band layer; an ethylene-vinyl acetate backing layer bonded to said polymer edge band layer through coextrusion; and an ethylene-vinyl acetate-based glue material applied to the ethylene-vinyl acetate backing layer to form a mixed ethylene-vinyl acetate-based glue layer.

In some embodiments, the mixed ethylene-vinyl acetate-based glue layer permeates the composite surface to form a bond between the mixed ethylene-vinyl acetate-based glue layer and the composite surface.

In some embodiments, the polymer edge band layer comprises polypropylene.

In some embodiments, the polymer edge band layer comprises a mixture of polypropylene and polyethylene.

In some embodiments, the polymer edge band layer comprises a material selected from the group consisting of polyethylene, polyvinyl chloride, and acrylonitrile butadiene styrene.

In some embodiments, the ethylene-vinyl acetate backing layer comprises ethylene-vinyl acetate with at least 18% vinyl acetate content.

In some embodiments, the ethylene-vinyl acetate backing layer comprises ethylene-vinyl acetate with between 18% and 26% vinyl acetate content.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1A is a sectional view of a wood composite surface member with an edge banding according to an example embodiment of the present invention;

FIG. 1B is an enlarged view of a portion of the wood composite surface member with edge banding shown in FIG. 1A, showing the edge banding in greater detail;

FIG. 2 is a cross-sectional elevation view of an edge banding in accordance with the present invention;

FIG. 3 is an exploded plan view of a die for co-extruding two thermoplastic materials; and

FIG. 4 is an elevation view of a co-extruder.

### DETAILED DESCRIPTION OF THE INVENTION

In some embodiments, the present invention comprises bonding an edge banding to a support surface, such as the edge of wood or wood composite furniture, by using a co-extruded dual compound edge banding that contains a main body of polymer edge band and an EVA backing layer. In some embodiments, the EVA backing layer has a thickness between 0.002 inches and 0.015 inches, the EVA in the backing layer having between 18% and 26% vinyl acetate content. The edge banding can be applied onto wood and wood composite furniture by furniture manufacturers using edge banding machines. The edge banding can be applied to a variety of other types of surfaces without departing from the scope and spirit of the present general inventive concept.

In some of its various example embodiments, the present general inventive concept provides materials and methods to replace the use of primer for bonding edge banding to a wood board or wood composite surface—as in certain types of furniture, for example, especially tables. In various embodiments, a primerless system of for attaching an edge banding to a wood surface can work with polypropylene, PVC, ABS, and other types of edge banding. As described below, several example embodiments of the present general inventive concept encompass the coextrusion of an EVA backing layer together with a top layer or edge band layer. Eliminating the need for primer allows furniture manufacturers to avoid assorted disadvantages associated with the use of primers—such as the limited shelf-life of primers, and the difficulty in getting a consistent layer of primer onto the wood surface or edge banding.

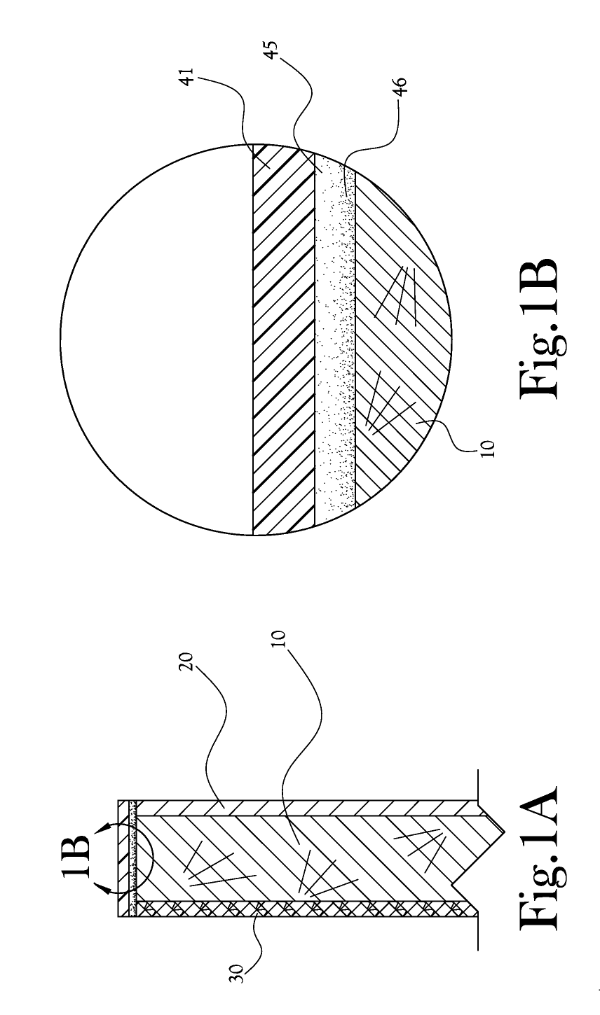

FIGS. 1A and 1B illustrate an example embodiment of an edge banding according to the present invention. FIG. 1A shows a section view of one edge of a table top or other furniture surface member, the surface member generally being fabricated from particleboard or a wood composite. In the illustrated example embodiment, a wood composite layer 10 is covered on one side by a layer 20 of formica and on the opposite side by a layer 30 of paper or similar material. The edge of the wood composite layer 10, seen in an enlarged view in the inset of FIG. 1B, is bonded to a polypropylene edge band 41 by an EVA backer layer 45. The primerless EVA backer layer 45 forms a mechanical bond with the wood composite material 10.

To apply an edge banding with EVA backer to a wood composite material, as with the example embodiment illustrated in FIGS. 1A and 1B, generally the polypropylene edge band 41 and the EVA backer 45 are coextruded. The coextruded edge band 41 and primerless EVA backer 45 are fed into an edge banding machine; the edge of the wood composite material 10 to which the edge band 41 and primerless EVA backer 45 will be applied is also fed into the edge banding machine. As the coextruded polypropylene edge band 41 and primerless EVA backer 45 are fed into the machine, heated EVA-based glue 46 is applied to the EVA backer 45. The hot EVA-based glue 46 heats and softens primerless EVA backer 45, so that primerless EVA backer 45 and the EVA-based glue 46 are bonded on a molecular level, and in the final product the distinction between the primerless EVA backer 45 and the EVA-based glue 46 is blurred and indefinite. The edge band 41, primerless EVA backer 45, and still-hot EVA-based glue 46 are then pressed into the edge of the wood composite material 10 under pressure, with the primerless EVA backer 45 and EVA-based glue 46 contacting the wood composite material 10. The hot EVA-based glue 46 permeates the wood composite material 10, forming a mechanical bond between the wood composite material 10 and the primerless EVA backer 45 and EVA-based glue 46. The heat of the EVA-based glue 46 and the pressure from the edge banding machine further strengthens bond between the polypropylene edge band 41 and the primerless EVA backer 45 and EVA-based glue 46.

Using the coextruded primerless EVA backer 45 and the EVA-based glue 46 to link the polypropylene edge band 41 with the composite wood material 10 results in a strong, “green” bonding between the polypropylene edge band 41 with the composite wood material 10. Significantly, this bonding between the edge band 41 and the composite wood material 10 is achieved without the use of a primer. Primers make an edge banding less “green” because they involve the use of various solvents and other chemicals that are not “green.” Primers also make an edge banding less reliable in the long term due to the simple fact that when using primers to improve bonds, the connection relies upon a very thin surface chemical bond between the primer and the glue, and between the primer and the polypropylene. Further, delamination caused by improper application of primer is eliminated.

In an example embodiment of the present invention, the primerless EVA backing layer has a thickness between 0.002 inches and 0.015 inches and comprises a blend of between 18% and 26% vinyl acetate content and the remainder polyethylene.

In an example embodiment, the edge band is about 0.020 to 0.120 inches in thickness and comprises polypropylene. A suitable source for polypropylene is sold by Formosa Plastic Company under the name FORMOLENE® 7320B.

In some embodiments, the edge band comprises a mixture of polypropylene and polyethylene. In some embodiments, the edge band comprises filled polypropylene. In some embodiments, the edge band comprises polyvinyl chloride (PVC). In some embodiments, the edge band comprises acrylonitrile butadiene styrene (ABS).

### Example Embodiment

An edge banding comprising an exposed outer layer of a thermoplastic selected from the group consisting of PP, ABS and PVC is coextruded with an under layer of EVA thermally bonded to the exposed outer layer is disclosed.

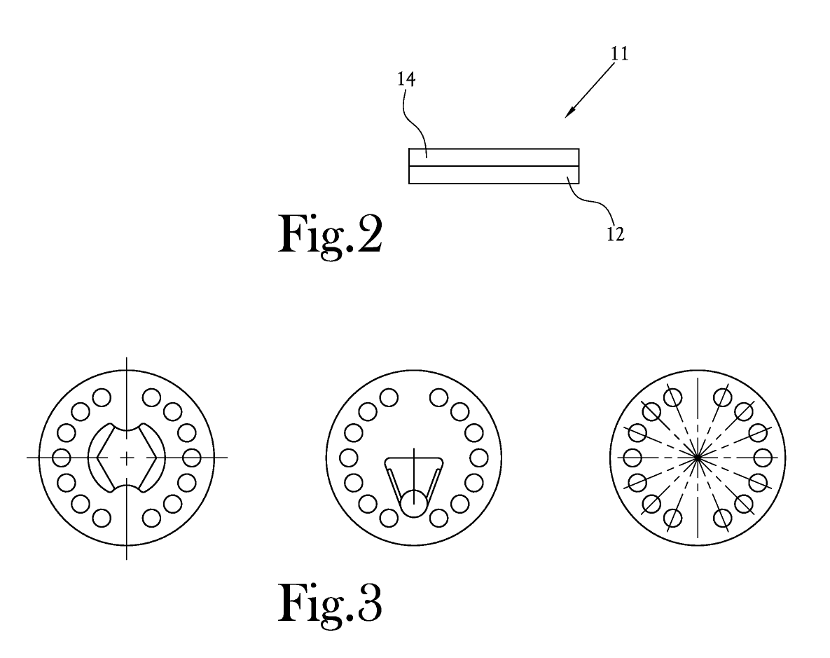

FIG. 2 illustrates a simplified schematic of one embodiment of edge banding 11 in accordance with the present invention. The edge banding 11 comprises an exposed outer layer 12, which is decorative and abrasion resistant, and an under layer 14 adapted for adhesive attachment to an edge of a board.

In one embodiment, the under layer 14 is approximately between 0.002 inches and 0.015 inches thick and comprises between 18% and 26% EVA. One source of suitable EVA is sold by Lyondell Chemical Company under the name ULTRATHENE® UE624000.

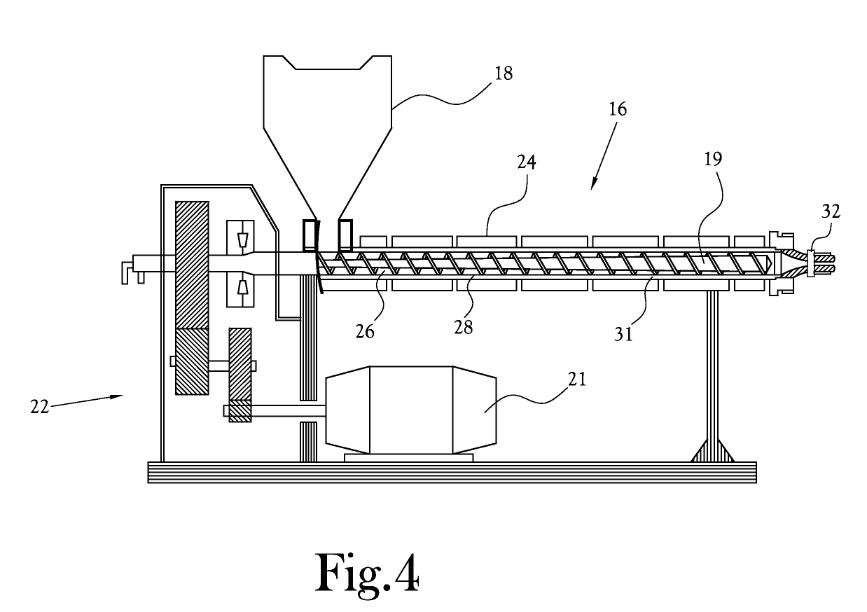

The outer layer 12 is about 0.020 to 0.120 inches in thickness and comprises polypropylene. A suitable source for polypropylene is sold by Formosa Plastic Company under the name FORMOLENE® 7320B. The two layers 12 and 14 are co-extruded through an extruder as illustrated in FIG. 4, at a temperature of about 340 to 420° F. and preferably at a temperature of about 400 to 420° F. to form a thermal bond between the two layers 12 and 14.

Polypropylene does not trim as easily as PVC. Accordingly, when trimming is an issue for the finished product, about 15%-20% of talc filler may be added to the polypropylene in the outer layer 12.

As discussed hereinabove, the outer exposed layer 12 may comprise ABS or PVC in similar dimensions. A suitable ABS is sold by the Formosa Chemicals & Fibre Corp under the name TAIRILAC® AG10AP.

The under layer 14 comprising EVA provides a secure attachment of the edge banding to a board using an EVA based adhesive because there is a thermal bond between the two layers 12 and 14 and a molecular bond between the EVA of the under layer 14 and the EVA adhesive. The prior need for a primer is eliminated. Delamination caused by improper application of primer is eliminated.

FIG. 4 discloses an apparatus 16 for co-extruding two thermoplastics. Thermoplastic pellets are fed through a hopper 18 into a barrel containing a screw 19. The screw 19 is rotated by a motor 21 through a gearing system 22. The screw 19 is surrounded by a plurality of heaters 24 for melting the thermoplastic pellets. The screw 19 advances the heated thermoplastic pellets through a feed zone 26, then a compression zone 28 and then a metering zone 31 before entering the die 32.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A method of applying an edge banding to a support surface without primer, comprising:
coextruding an edge band layer and an ethylene-vinyl acetate (EVA) backing layer such that a bond forms between the edge band layer and the EVA backing layer, forming a primerless edge banding; and
applying an EVA-based glue to a support surface such that a bond forms between the EVA-based glue layer and the support surface;
wherein the bonding between the EVA-based glue layer and the support surface is achieved without the use of a primer

2. The method of claim 1 wherein said edge band layer comprises polypropylene.

3. The method of claim 1 wherein said edge band layer comprises a material selected from the group consisting of polyethylene, polyvinyl chloride, and acrylonitrile butadiene styrene.

4. The method of claim 1 wherein said ethylene-vinyl acetate backing layer comprises ethylene-vinyl acetate with at least 18% vinyl acetate content.

5. The method of claim 4 wherein said ethylene-vinyl acetate backing layer comprises ethylene-vinyl acetate with between 18% and 26% vinyl acetate content.

6. An edge banding for a composite surface, comprising:
a polymer edge band layer;
an ethylene-vinyl acetate backing layer bonded to said polymer edge band layer through coextrusion; and
an ethylene-vinyl acetate-based glue material applied to the ethylene-vinyl acetate backing layer to form a mixed ethylene-vinyl acetate-based glue layer.

7. The edge banding of claim 6 wherein the mixed ethylene-vinyl acetate-based glue layer permeates the composite surface to form a bond between the mixed ethylene-vinyl acetate-based glue layer and the composite surface.

8. The edge banding of claim 6 wherein said polymer edge band layer comprises polypropylene.

9. The edge banding of claim 6 wherein said polymer edge band layer comprises a mixture of polypropylene and polyethylene.

10. The edge banding of claim 6 wherein said polymer edge band layer comprises a material selected from the group consisting of polyethylene, polyvinyl chloride, and acrylonitrile butadiene styrene.

11. The edge banding of claim 6 wherein said ethylene-vinyl acetate backing layer comprises ethylene-vinyl acetate with at least 18% vinyl acetate content.

12. The edge banding of claim 11 wherein said ethylene-vinyl acetate backing layer comprises ethylene-vinyl acetate with between 18% and 26% vinyl acetate content.
